(19) United States
(12) Patent Application Publication
(10) Pub. No.: US 2022/0266472 A1
(43) Pub. Date: Aug. 25, 2022

(54) BLADE GUARD FOR CIRCULAR SAW BLADE

(71) Applicant: Tractive AB, Borlänge (SE)

(72) Inventor: Anders Johnsen, Borlänge (SE)

(21) Appl. No.: 17/674,414

(22) Filed: Feb. 17, 2022

(30) Foreign Application Priority Data
Feb. 19, 2021 (EP) 21158216.8

(51) Int. Cl. B27G 19/04

(52) U.S. Cl. CPC B27G 19/04

(57) ABSTRACT

Blade guard (20) configured to partially cover a rear face of a circular saw blade (9) while leaving a front face (9b) of the saw blade uncovered. The blade guard comprises:
a guard plate (21) having an inner face (21a) configured to face the saw blade (9); and
an elongated shielding unit (50) fixed to the guard plate (21) and configured to cover a part of the peripheral edge (14) of the saw blade.

The shielding unit comprises several shielding elements (52) arranged side by side along the shielding unit, each shielding element comprising a shielding member (53) and a resilient cantilever support member (54), wherein the shielding members are arranged side by side in a row in order to form an elongated barrier (55) capable of stopping cutting debris. The support members (54) allow the shielding members (53) to move in relation to each other and in relation to the guard plate (21).

### FIELD OF THE INVENTION AND PRIOR ART

The present invention relates to a blade guard according to the description herein. The invention also relates to power driven saw comprising such a blade guard.

A power driven saw may for instance have the form of a so-called wall saw. A wall saw is primarily used for cutting walls, ceilings or floors made of concrete or similar materials. A conventional wall saw comprises a carriage which is moveable along a guide rail by means of a feeding device. A circular saw blade is mounted to a spindle, which is rotatably mounted to a saw arm. The saw arm is in its turn pivotally mounted to the carriage. The spindle is rotated by means of a drive motor, which is mounted to the carriage and operatively connected to the spindle through a transmission mechanism accommodated in the saw arm. When the saw arm is pivoted, the saw blade is moved upwards or downwards for adjustment of the depth of the cut. The saw arm may be pivoted by means of a motor or a manually operated actuating device mounted to the carriage.

Wall saws of the above-mentioned type are for instance disclosed in U.S. Pat. Nos. 3,722,497 A, 8,789,521 B2 and 9,623,587 B2.

Concrete dust and heat are generated when a saw blade of a wall saw cuts through a concrete structure. The saw blade has to be cooled in order to prevent the saw blade from loosing its stability due to overheating. The concrete structure may be flushed with water in order to subject the saw blade to cooling and at the same time reduce the generation of airborne dust. A blade guard may be arranged around the saw blade in order to prevent flushing water and mud from splashing into the surroundings under the effect of the rapidly rotating saw blade. When the wall saw is used for performing a flush cutting operation with a front face of the saw blade located very close to and in parallel with an essentially flat first surface that extends at an angle to a second surface to be cut by the saw blade, the blade guard is with advantage configured to leave the front face of the saw blade uncovered to thereby allow the front face of the saw blade to be positioned as close as possible to the first surface. In this case, the blade guard is normally provided with flexible elongated splash protection elements in the form of rubber strips or brush strips along a part of the periphery of the blade guard in order to prevent water and mud from splashing out of the blade guard and into the surroundings during the flush cutting operation. However, larger pieces of cutting debris formed during a flush cutting operation may penetrate through the splash protection elements and be ejected at high speed into the surroundings, which may cause injuries to the saw operator or other persons in the vicinity of the wall saw.

### OBJECT OF THE INVENTION

The object of the present invention is to provide a blade guard that has a new and favourable design.

### SUMMARY OF THE INVENTION

According to the present invention, said object is achieved by means of a blade guard having the features defined herein.

The blade guard according to the invention is to be used with a circular saw blade of a power driven saw, wherein the blade guard is configured to partially cover a rear face of the saw blade while leaving an opposite front face of the saw blade uncovered, the blade guard comprising:
a guard plate configured to partially cover the rear face of the saw blade, the guard plate having an inner face configured to face the saw blade and an opposite outer face; and
at least one elongated shielding unit fixed to the guard plate and configured to cover a part of the peripheral edge of the saw blade.

The blade guard is open along a section of the periphery of the guard plate in order to allow a segment of the saw blade to project from the blade guard beyond this section.

Said shielding unit comprises a holding structure fixed to the guard plate and several shielding elements fixed to the holding structure and arranged side by side along the shielding unit, each shielding element comprising a shielding member and a resilient cantilever support member having an inner end and an opposite outer end, wherein:
the shielding members of the shielding unit are arranged side by side in a row in order to form an elongated barrier that is configured to prevent cutting debris formed during a sawing operation from being ejected out of the blade guard;
the support member of each shielding element is fixed to the holding structure at its inner end; and
the shielding member of each shielding element is fixed to the associated support member at the outer end thereof and resiliently connected to the holding structure via this support member, such that the support members of the shielding unit allow the shielding members of the shielding unit to move in relation to each other and in relation to the guard plate when the blade guard is pressed against a surface that extends essentially in parallel with the guard plate.

The blade guard according the invention is adapted for use in a flush cutting operation with the front face of the saw blade located close to and in parallel with an essentially flat surface, wherein the shielding members are configured to be in contact with said surface and prevent cutting debris from being ejected out of the blade guard and into the surroundings under the effect of the rotating saw blade during the flush cutting operation. The resilient mounting of the shielding members to the guard plate by the resilient support members makes it possible for the shielding members to be pressed tightly against said surface while adapting to possible irregularities in the surface.

The blade guard according the invention is particularly intended for use with a wall saw, but it may also be designed for use with a power driven saw in the form of a hand-held circular saw.

According to an embodiment of the invention, the shielding member of each shielding element has the form of a flat tooth, wherein the support member of each shielding element preferably has the form of a flat beam. Shielding elements formed by flat teeth and flat beams may perform their intended function in a reliable and efficient manner and may be produced in a simple and cost-efficient manner.

According to another embodiment of the invention, the support member of each shielding element extends essentially in parallel with the guard plate, wherein the shielding member of each shielding element with advantage is configured to extend from the associated support member at an angle of 70-110°, preferably 75-90°.

According to another embodiment of the invention, the holding structure and the shielding elements of said shielding unit are of metal sheet and are formed in one piece, preferably in a piece of metal sheet by laser cutting and bending. Hereby, the shielding unit may be produced in a simple and cost-efficient manner.

The shielding members of the shielding unit are preferably arranged side by side in a rectilinear or at least essentially rectilinear row, and the holding structure of the shielding unit is preferably fixed to the inner face of the guard plate.

According to another embodiment of the invention, the blade guard comprises at least one flexible elongated splash protection element, preferably in the form of a rubber strip or a brush strip, which is fixed to the guard plate so as to project from the inner face thereof and which extends along the elongated barrier formed by the shielding members of said shielding unit in order to prevent water and mud from splashing out of the blade guard and into the surroundings during a flush cutting operation. Said splash protection element is with advantage arranged on the inner face of the guard plate outwardly of said elongated barrier. As mentioned above, the barrier formed by the shielding members is configured to prevent cutting debris from being ejected out of the blade guard during a flush cutting operation. The shielding members may also prevent some of the cooling water and mud from splashing out of the blade guard. However, by combining the barrier formed by the shielding members with one or more flexible elongated splash protection elements, a more efficient protection against splashing of cooling water and mud is achieved.

When the blade guard is of larger size, and particularly when it comprises a guard plate of polygonal shape, the blade guard may comprise several shielding units of the above-mentioned type, which are arranged in series with each other and configured to cover a respective part of the peripheral edge of the saw blade.

According to another embodiment of the invention, at least two spacer elements are fixed to the guard plate on the inner face thereof inwardly of said elongated barrier and at a distance from each other, wherein these spacer elements project from the inner face of the guard plate and are intended to be in sliding contact with the rear face of the saw blade in order to maintain a given spacing between the guard plate and the saw blade. The spacer elements will prevent the guard plate from coming to close to the saw blade when the guard plate is positioned in an essentially horizontal position and subjected to bending under the effect of gravity.

Further advantageous features of the blade guard according to the present invention will appear from the description following below.

The invention also relates to a power driven saw having the features defined herein.

Further advantageous features of the power driven saw according to the present invention will appear from the description following below.

### BRIEF DESCRIPTION OF THE DRAWINGS

With reference to the appended drawings, a specific description of preferred embodiments of the invention cited as examples follows below. In the drawings:

FIG. 1 is a perspective view of a wall saw with a blade guard according to an embodiment of the present invention, as seen with the blade guard detached from the wall saw,

FIG. 2 is a perspective view of the wall saw and blade guard of FIG. 1, as seen from another direction and with a saw blade detached from the wall saw,

FIG. 3 is a perspective view of the wall saw and blade guard of FIG. 1, as seen with the blade guard mounted to the wall saw,

FIG. 4 is a rear view of the wall saw and blade guard of FIG. 3,

FIG. 5 is a front view of the wall saw and blade guard of FIG. 3,

FIG. 6 is a lateral view of the wall saw and blade guard of FIG. 3,

FIG. 7 is a cut according to the line VII-VII in FIG. 5,

FIG. 8 is a perspective view of a part of the blade guard of FIG. 1 and a part of a saw blade,

FIG. 9 is a perspective view of a part of the blade guard of FIG. 1,

FIG. 10 is a perspective view of a shielding unit included in the blade guard of FIG. 1, and

FIG. 11 is an exploded view of a part of the blade guard of FIG. 1.

### DETAILED DESCRIPTION OF EMBODIMENTS OF THE INVENTION

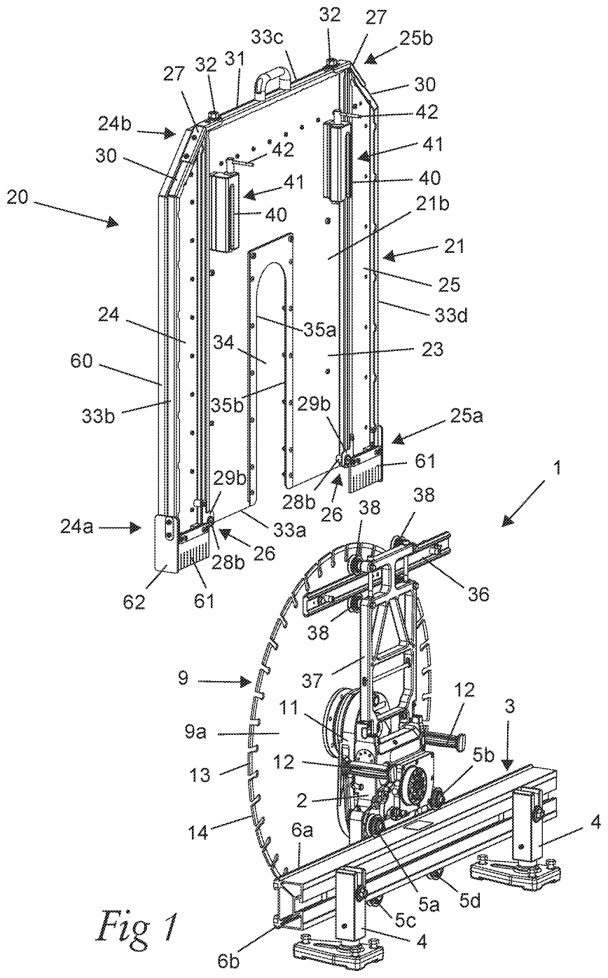

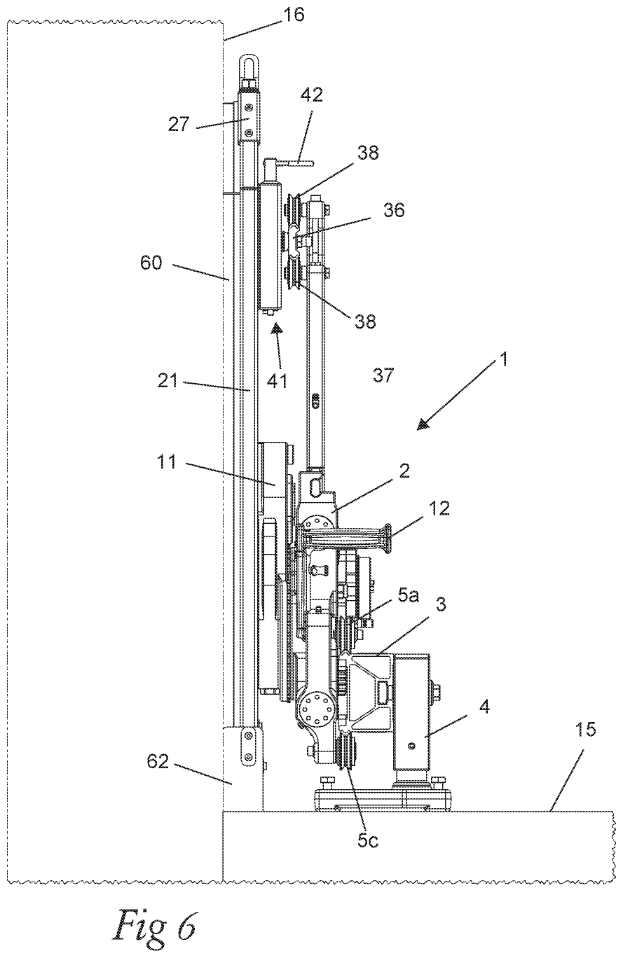

A power driven saw 1 in the form of a wall saw provided with a blade guard 20 according to an embodiment of the present invention is illustrated in FIGS. 1-7. This power driven saw 1 is primarily intended to be used for cutting walls, ceilings or floors made of concrete or similar materials. The power driven saw 1 comprises a carriage 2, which is mounted to an elongated guide rail 3 so as to be moveable along the guide rail. The guide rail 3 is to be mounted to a floor or a wall or other supporting surface by means of support members 4, which are secured to the guide rail 3.

Guide rollers 5a-5d are rotatably mounted to the carriage 2. These guide rollers 5a-5d are in engagement with guide tracks 6a, 6b on the guide rail 3 and are configured to keep the carriage 2 in place on the guide rail 3, while allowing the carriage 2 to move along the guide rail 3 in the longitudinal direction thereof. In the illustrated embodiment, the guide rail 3 is provided with an upper guide track 6a and a lower guide track 6b, which extend in parallel with each other along the guide rail. In the illustrated embodiment, two guide rollers 5a, 5b are in engagement with the upper guide track 6a from above and two other guide rollers 5c, 5d are in engagement with the lower guide track 6b from below.

A cog track 7 is fixed to the guide rail 3 and extends in the longitudinal direction thereof in parallel with the guide tracks 6a, 6b. The carriage 2 is moveable along the cog track 7 by means of a feeding device, which comprises a feed gear wheel that is rotatably mounted to the carriage 2. The feed gear wheel is in engagement with the cog track 7. The feeding device also comprises a feed motor mounted to the carriage 2, by means of which the feed gear wheel is rotatable in order to move the carriage 2 along the guide rail 3. The feed motor is preferably an electric motor, but could alternatively be a hydraulic motor.

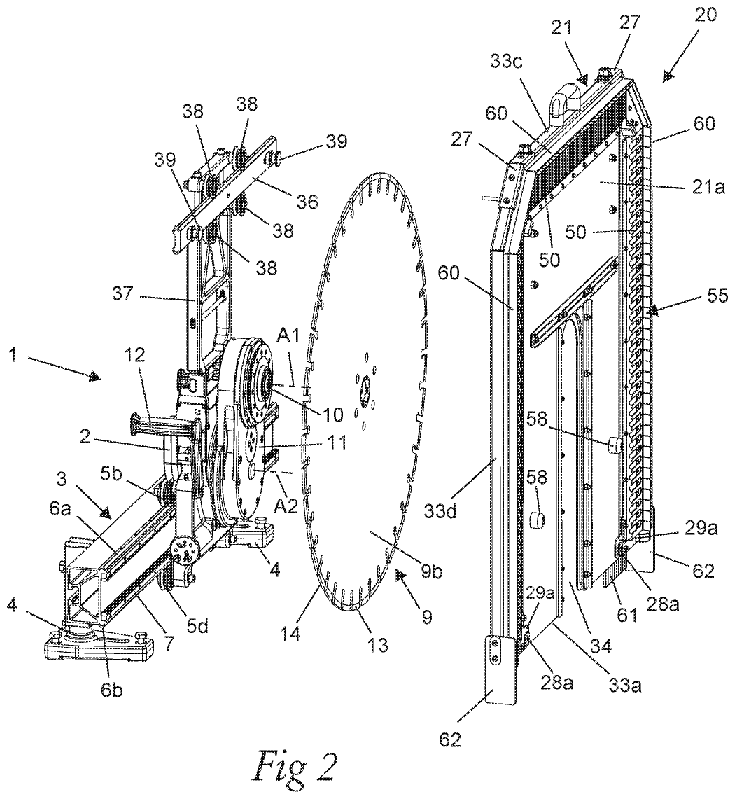

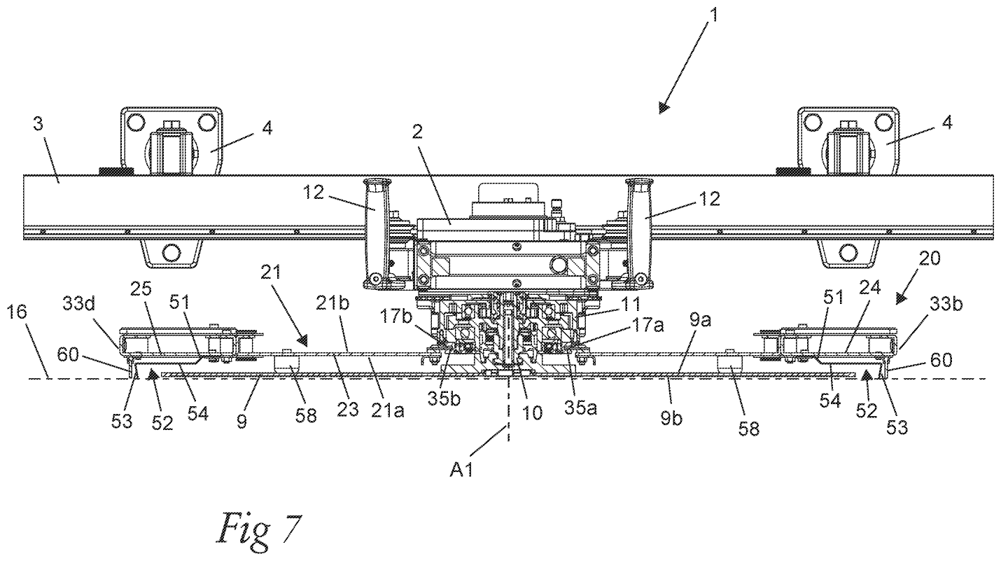

A circular saw blade 9 is attached to a rotatable spindle 10 of the power driven saw 1. In FIG. 2, the power driven saw 1 is shown with the saw blade 9 detached from the spindle 10. The saw blade 9 is detachably attachable to the spindle 10 by means of a suitable coupling. The spindle 10 is rotatably mounted to a saw arm 11 by means of suitable bearings and is rotatable about an axis of rotation A1 (see FIGS. 2 and 7). The spindle 10 is driven in rotation by means of an electric drive motor, which is mounted to the carriage 2. Driving torque is transmitted from an output shaft of the drive motor to the spindle 10 through a transmission mechanism. The transmission mechanism may comprise a set of gear wheels acting between the output shaft of the drive motor and the spindle 10. As an alternative to gear wheels, the transmission mechanism could be provided with a driving chain or driving belt for transmitting driving torque from the output shaft of the drive motor to the spindle 10.

The saw arm 11 is pivotally mounted to the carriage 2 by means of suitable bearings and is pivotable about a pivot axis A2 (see FIG. 2), which is perpendicular to the longitudinal axis of the guide rail 3 and parallel to the axis of rotation A1 of the spindle 10. The saw arm 11 is adjustable into different rotational positions in relation to the carriage 2 by being pivoted about the pivot axis A2. The wall saw 1 comprises an actuating device for pivoting the saw arm 11 in relation to the carriage 2 about the pivot axis A2. The actuating device comprises a motor mounted to the carriage 2. This motor is preferably an electric motor, but could alternatively be a hydraulic motor.

The carriage 2 may be lifted and carried by means of handles 12 mounted to the carriage.

The saw blade 9 has a rear face 9a facing the carriage 2 and the saw arm 11 and an opposite front face 9b facing away from the carriage 2 and the saw arm 11. Cutting members 13 are arranged on a peripheral edge 14 of the saw blade 9 and distributed in the circumferential direction of this peripheral edge 14.

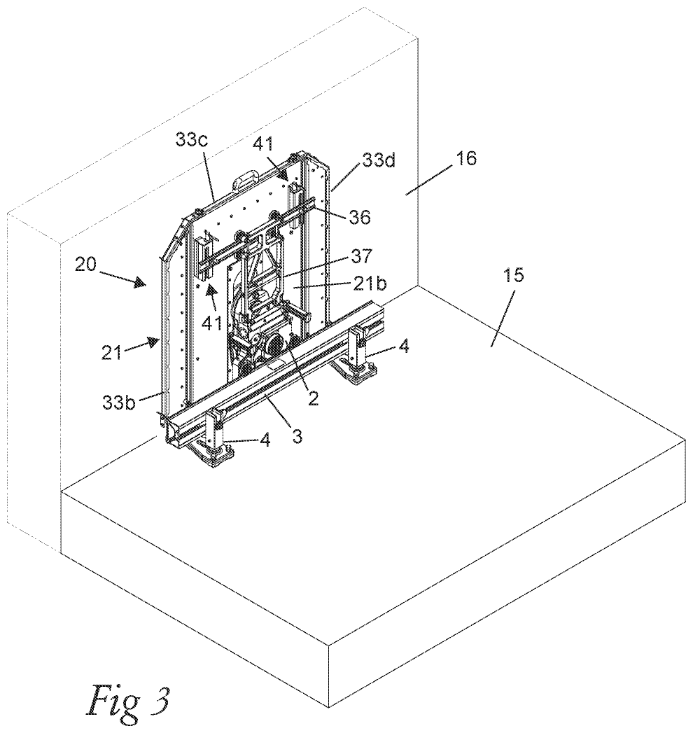

The blade guard 20 is detachably mountable to the carriage 2. When mounted to the carriage 2, the blade guard 20 is configured to partially cover the rear face 9a of the saw blade 9 while leaving the front face 9b of the saw blade uncovered, to thereby allow the power driven saw 1 to be used in a flush cutting operation with the blade guard 20 mounted to the carriage 2, as illustrated in FIGS. 3-7.

In the example illustrated in FIGS. 3-7, the guide rail 3 is mounted to a first surface 15 in the form of a floor surface in such a position that the saw blade 9 extends in parallel with a second surface 16 in the form of a wall surface. In this case, a cut is to be made in the first surface 15 essentially flush with the second surface 16, and the saw blade 9 is therefore positioned with its front face 9b as close as possible to the second surface 16, as illustrated in FIG. 7.

The blade guard 20 comprises a guard plate 21, which is configured to cover the main part of the rear face 9a of the saw blade 9 when the blade guard 20 is mounted to the power driven saw 1. The guard plate 21 has an inner face 21a that is configured to face the saw blade 9 and an opposite outer face 21b. Thus, the inner face 21a of the guard plate 21 is facing the second surface 16 and the outer face 21b of the guard plate 21 is facing away from the second surface 16 in the example illustrated in FIGS. 3-7.

In the illustrated embodiment, the guard plate 21 is divided into three separate parts, including a central main part 23 and two smaller side parts 24, 25 arranged on opposite sides of the main part 23. In the illustrated example, each side part 24, 25 has a lower end 24a, 25a and an opposite upper end 24b, 25b and is detachable mounted to the main part 23 by means of a coupling mechanism 26 and a fastening member 27. Said coupling mechanism 26 comprises two pin-shaped first coupling members 28a, 28b, which are arranged on opposite sides of the main part 23, and two hook-shaped second coupling members 29a, 29b, which are arranged in parallel with each other on opposite sides of the associated side part 24, 25 at the lower end 24a, 25a thereof and which are configured for engagement with a respective one of said first coupling members 28a, 28b. Said fastening member 27 has the form of a corner bracket, which is fixed to an edge 30 at the upper end 24b, 25b of the associated side part 24, 25 and releasably secured to an upper edge 31 of the main part 23 by means of a fastening element 32 in the form of a threaded nut. The side parts 24, 25 may of course be mounted to the main part 23 in any other suitable manner. As a further alternative, the guard plate 21 may be formed in one piece.

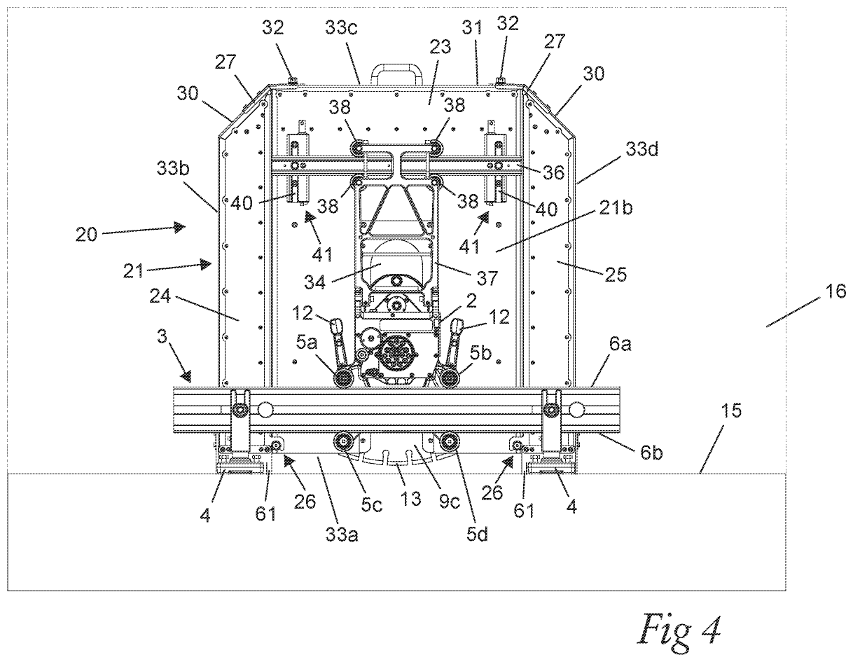

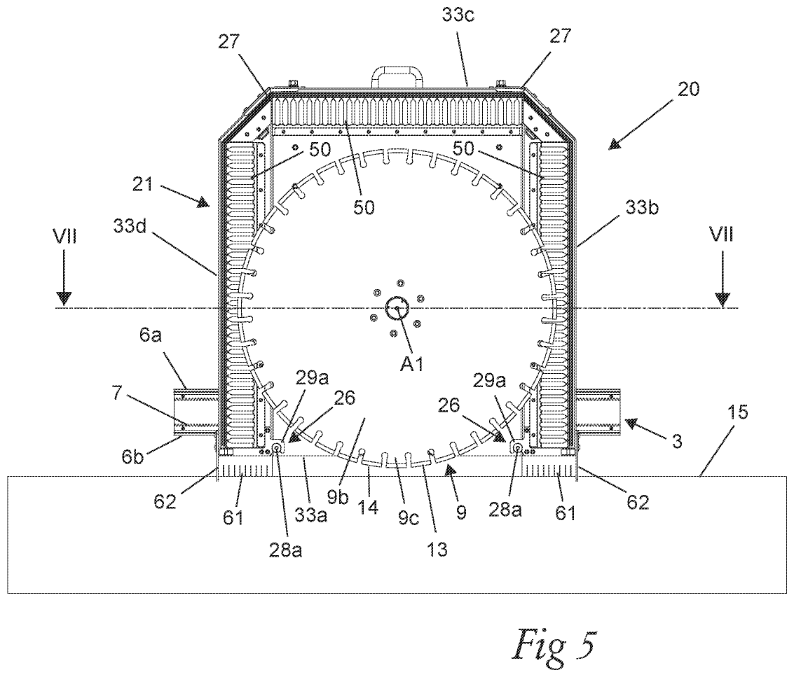

The blade guard 20 is open along a section 33a of the periphery of the guard plate 21 in order to allow a segment 9c (see FIGS. 4 and 5) of the saw blade 9 to project from the blade guard 20 beyond this section 33a.

An elongated recess 34 is provided in the guard plate 21, wherein the spindle 10 is configured to extend through this recess 34 when the blade guard 20 is mounted to the power driven saw 1. The recess 34 is open towards the above-mentioned section 33a of the periphery of the guard plate 21. Longitudinal edges 35a, 35b on opposite sides of the recess 34 are configured to be slidably received in a respective groove 17a, 17b in the saw arm 11 on opposite sides of the spindle 10 when the blade guard 20 is mounted to the power driven saw 1.

When mounted to the power driven saw 1, the blade guard 20 is connected to the carriage 2 in order to be moveable along the guide rail 3 together with the carriage. In the illustrated example, the blade guard 20 is connected to the carriage 2 via an elongated suspension rail 36, which is releasably fixed to the blade guard 20 on a rear side thereof, and a supporting device 37, which is fixed to the carriage 2 and provided with rotatable guide rollers 38. These guide rollers 38 are in engagement with the suspension rail 36 and are configured to allow the blade guard 20 to move in relation to the carriage 2 in the longitudinal direction of the guide rail 3 when the saw arm 11 is pivoted in relation to the carriage 2, while keeping the guard plate 21 at a fixed distance from the above-mentioned first surface 15. When the saw arm 11 is pivoted in relation to the carriage 2, the spindle 10 will move along the recess 34 in the guard plate 21 and the guard plate 21 will be pushed by the saw arm 11 to move in relation to the carriage 2 in the longitudinal direction of the guide rail 3. When the carriage 2 is moved along the guide rail 3, the guard plate 21 will move together with the carriage 2 and the saw arm 11 in the longitudinal direction of the guide rail 3.

In the illustrated example, two coupling members 39 (see FIG. 2) are fixed to the suspension rail 36 at opposite ends thereof and are configured for engagement in a slot 40 (see FIG. 1) in a respective coupling member 41 that is fixed to the guard plate 21 on the outer face 21b thereof. Each coupling member 39 on the suspension rail 36 is locked in place in the slot 40 in the associated coupling member 41 on the guard plate 21 by means of a locking member (not shown) that is operated by a handle 42 arranged on the last-mentioned coupling member 41.

Elongated shielding units 50 are fixed to the guard plate 21, wherein these shielding units 50 are arranged in series with each other and configured to cover a respective part of the peripheral edge 14 of the saw blade 9 when the blade guard 20 is mounted to the power driven saw 1. The shielding units 50 extend along a respective section 33b, 33c, 33d of the periphery of the guard plate 21, but no shielding unit is arranged along the above-mentioned open section 33a of the periphery of the guard plate 21.

Each shielding unit 50 comprises an elongated holding structure 51, which fixed to the guard plate 21, and several shielding elements 52, which are fixed to the holding structure 51 and arranged side by side along the shielding unit 50. Each shielding element 52 comprises a shielding member 53 and a resilient cantilever support member 54 with an inner end 54a and an opposite outer end 54b. The shielding members 53 of each individual shielding unit 50 are arranged side by side in a row in order to form an elongated barrier 55 that is capable of preventing cutting debris, such as pieces of concrete, formed during a flush cutting operation from being ejected out of the blade guard 20 and into the surroundings. The support member 54 of each shielding element 52 is fixed to the holding structure at its inner end 54a. The shielding member 53 of each shielding element 52 is fixed to the associated support member 54 at the outer end 54b thereof and resiliently connected to the holding structure 51 via this support member 54. Thus, the support members 54 of each individual shielding unit 50 form resilient connections between the shielding members 53 and the holding structure 51 of the shielding unit 50 and allow these shielding members 53 to move in relation to each other and in relation to the holding structure 51 and the guard plate 21 when the blade guard 20 is pressed against a surface that extends essentially in parallel with the guard plate 21, i.e. the above-mentioned second surface 16 in the example illustrated in FIGS. 3-7.

In the illustrated embodiment, the guard plate 21 has a polygonal shape and the shielding members 53 of each individual shielding unit 50 are in this case arranged side by side in a rectilinear or at least essentially rectilinear row so as to form an essentially rectilinear barrier 55 that extends in parallel with the associated rectilinear section 33b, 33c, 33d of the periphery of the guard plate 21.

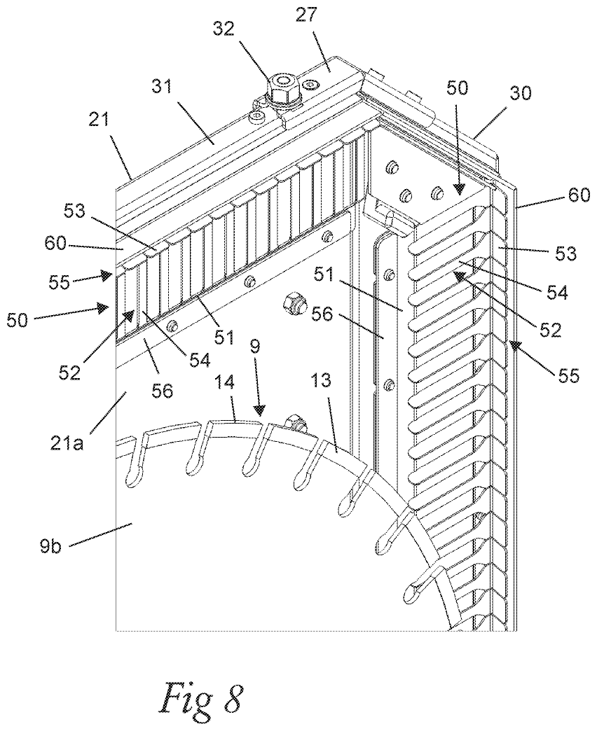

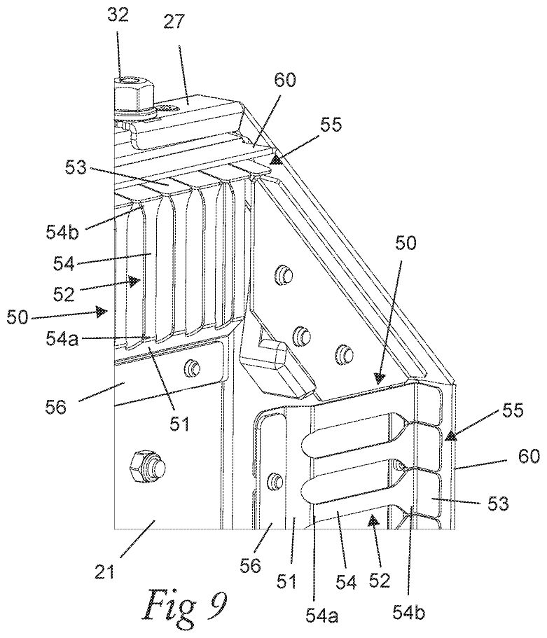

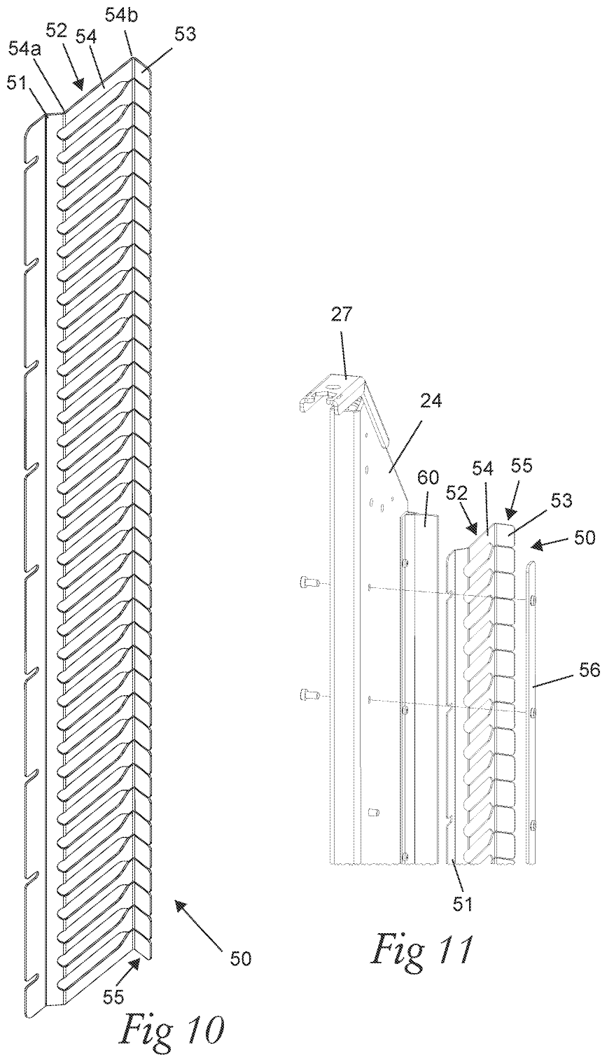

In the illustrated embodiment, the holding structure 51 of each individual shielding unit 50 is fixed to the inner face 21a of the guard plate 21 and the shielding elements 52 project from the inner face 21a of the guard plate 21. The holding structure 51 of each individual shielding unit 50 may for instance be fixed to the inner face 21a of the guard plate 21 by being clamped between an elongated mounting plate 56 and the guard plate 21, as illustrated in FIGS. 8 and 11. In the illustrated example, said mounting plate 56 is fixed to the guard plate 21 by riveting. However, each holding structure 51 may of course also be fixed to the guard plate 21 in any other suitable manner.

In the illustrated embodiment, each shielding member 53 has the form of a flat tooth and each support member 54 has the form of a flat beam. However, the shielding members 53 and/or the support members 54 may as an alternative be pin-shaped or have any other suitable shape. The shielding members 53 and the support members 54 are preferably of metallic material, such as for instance steel, but may as an alternative be of plastic material. The holding structure 51 and the shielding elements 52 of each individual shielding unit 50 are with advantage of metal sheet and formed in one piece, for instance by laser cutting and bending.

Each support member 54 preferably extends essentially in parallel with the guard plate 21, as illustrated in FIG. 7. In this case, each shielding member 53 is with advantage configured to extend from the associated support member 54 at an angle of 70-110°, preferably 75-90°.

In the illustrated embodiment, the blade guard 20 also comprises flexible elongated splash protection elements 60, which are fixed to the guard plate 21 so as to project from the inner face 21a thereof and which extend along the elongated barriers 55 formed by the shielding members 53 of the shielding units 50 in order to prevent cooling water and mud from splashing out of the blade guard 20 and into the surroundings during a flush cutting operation. Each splash protection element 60 is preferably arranged on the inner face 21a of the guard plate 21 outwardly of the associated elongated barrier 55. In the illustrated embodiment, each splash protection element 60 has the form of a rubber strip. As an alternative, each splash protection element 60 may have the form of a brush strip. The blade guard 20 may be designed without any such splash protection elements 60, if so desired.

In the illustrated embodiment, the blade guard 20 is also provided with flexible splash protection elements in the form of rubber flaps 61, 62, which are fixed to the guard plate 21 so as to project from the guard plate on either side of the above-mentioned open section 33a of the periphery of the guard plate 21 and make contact with the surface that supports the guide rail 3, i.e. the above-mentioned first surface 15 in the example illustrated in FIGS. 3-7.

In the illustrated embodiment, two spacer elements 58 are fixed to the guard plate 21 on the inner face 21a thereof inwardly of the elongated barriers 55 formed by the shielding members 53 of the shielding units 50 and at a distance from each other. The spacer elements 58 are arranged on either side of the above-mentioned recess 34 in the guard plate 21. The spacer elements 58 project from the inner face 21a of the guard plate 21 and are intended to be in sliding contact with the rear face 9a of the saw blade 9 in order to maintain a given spacing between the guard plate 21 and the saw blade 9.

The invention is of course not in any way restricted to the embodiments described above. On the contrary, many possibilities to modifications thereof will be apparent to a person with ordinary skill in the art without departing from the basic idea of the invention such as defined in the appended claims.

1. A blade guard for a circular saw blade (9) of a power driven saw (1), wherein the blade guard (20) is configured to partially cover a rear face (9a) of the saw blade (9) while leaving an opposite front face (9b) of the saw blade uncovered, the blade guard (20) comprising:
a guard plate (21) configured to partially cover the rear face (9a) of the saw blade (9), the guard plate (21) having an inner face (21a) configured to face the saw blade (9) and an opposite outer face (21b); and
at least one elongated shielding unit (50) fixed to the guard plate (21) and configured to cover a part of the peripheral edge (14) of the saw blade (9), wherein
the blade guard (20) is open along a section (33a) of the periphery of the guard plate (21) in order to allow a segment (9c) of the saw blade (9) to project from the blade guard (20) beyond this section (33a);
said shielding unit (50) comprises a holding structure (51) fixed to the guard plate (21) and several shielding elements (52) fixed to the holding structure (51) and arranged side by side along the shielding unit (50), each shielding element (52) comprising a shielding member (53) and a resilient cantilever support member (54) having an inner end (54a) and an opposite outer end (54b);
the shielding members (53) of the shielding unit (50) are arranged side by side in a row to form an elongated barrier (55) that is configured to prevent cutting debris formed during a sawing operation from being ejected out of the blade guard (20);
the support member (54) of each shielding element (52) is fixed to the holding structure (51) at its inner end (54a); and
the shielding member (53) of each shielding element (52) is fixed to the associated support member (54) at the outer end (54b) thereof and resiliently connected to the holding structure (51) via this support member (54), such that the support members (54) of the shielding unit (50) allow the shielding members (53) of the shielding unit (50) to move in relation to each other and in relation to the guard plate (21) when the blade guard (20) is pressed against a surface that extends essentially in parallel with the guard plate (21).

2. A blade guard according to claim 1, wherein the shielding member (53) of each shielding element (52) has the form of a flat tooth.

3. A blade guard according to claim 2, wherein the support member (54) of each shielding element (52) has the form of a flat beam.

4. A blade guard according to claim 1, wherein the support member (54) of each shielding element (52) extends essentially in parallel with the guard plate (21).

5. A blade guard according to claim 4, wherein the shielding member (53) of each shielding element (52) extends from the associated support member (54) at an angle of 70-110°, preferably 75-90°.

6. A blade guard according to claim 1, wherein the holding structure (51) and the shielding elements (52) of said shielding unit (50) are of metal sheet and are formed in one piece.

7. A blade guard according to claim 6, wherein the holding structure (51) and the shielding elements (52) are formed in a piece of metal sheet by laser cutting and bending.

8. A blade guard according to claim 1, wherein the shielding members (53) of said shielding unit (50) are arranged side by side in a rectilinear or at least essentially rectilinear row.

9. A blade guard according to claim 1, wherein the holding structure (51) of said shielding unit (50) is fixed to the inner face (21a) of the guard plate (21).

10. A blade guard according to claim 1, wherein the blade guard (20) comprises at least one flexible elongated splash protection element (60) that is fixed to the guard plate (21) to project from the inner face (21a) thereof and that extends along the elongated barrier (55) formed by the shielding members (53) of said shielding unit (50) to prevent water and mud from splashing out of the blade guard (20) during a sawing operation.

11. A blade guard according to claim 10, wherein said splash protection element (60) is arranged on the inner face (21a) of the guard plate (21) outwardly of said elongated barrier (55).

12. A blade guard according to claim 10, wherein said splash protection element (60) has the form of a rubber strip or a brush strip.

13. A blade guard according to claim 1, wherein the blade guard (20) comprises several such shielding units (50), which are arranged in series with each other and configured to cover a respective part of the peripheral edge (14) of the saw blade (9).

14. A blade guard according to claim 1, wherein at least two spacer elements (58) are fixed to the guard plate (21) on the inner face (21a) thereof inwardly of said elongated barrier (55) and at a distance from each other, and these spacer elements (58) project from the inner face (21a) of the guard plate (21) and are in sliding contact with the rear face (9a) of the saw blade (9) to maintain a given spacing between the guard plate (21) and the saw blade (9).

15. A power driven saw comprising a circular saw blade (9), wherein the power driven saw (1) comprises a blade guard (20) according to claim 1.

16. A blade guard according to claim 3, wherein the support member (54) of each shielding element (52) extends essentially in parallel with the guard plate (21).

17. A blade guard according to claim 2, wherein the support member (54) of each shielding element (52) extends essentially in parallel with the guard plate (21).

18. A blade guard according to claim 17, wherein the shielding member (53) of each shielding element (52) extends from the associated support member (54) at an angle of 70-110°, preferably 75-90°.

19. A blade guard according to claim 16, wherein the shielding member (53) of each shielding element (52) extends from the associated support member (54) at an angle of 70-110°, preferably 75-90°.

20. A blade guard according to claim 19, wherein the holding structure (51) and the shielding elements (52) of said shielding unit (50) are of metal sheet and are formed in one piece.
